(19) United States
(12) Patent Application Publication
(10) Pub. No.: US 2014/0069263 A1
(43) Pub. Date: Mar. 13, 2014

(54) METHOD FOR AUTOMATIC ACCOMPANIMENT GENERATION TO EVOKE SPECIFIC EMOTION

(71) Applicant: National Taiwan University, Taipei (TW)

(72) Inventors: Pei-Chen CHEN, Taipei City (TW); Keng-Sheng LIN, Taipei City (TW); Homer H. CHEN, Taipei City (TW)

(73) Assignee: NATIONAL TAIWAN UNIVERSITY, Taipei (TW)

(21) Appl. No.: 14/026,231

(22) Filed: Sep. 13, 2013

(30) Foreign Application Priority Data
Sep. 13, 2012 (TW) 101133568

(51) Int. Cl. G10H 1/36; G10H 1/38

(52) U.S. Cl. CPC G10H 1/36; G10H 1/38
USPC 84/613; 84/610

(57) ABSTRACT

A method for automatic accompaniment generation to evoke specific emotion includes the steps of receiving a melody and a valence value, executing an accompaniment module, wherein the accompaniment module execution includes generating at least one harmonic progression composed of multiple chords corresponding to the valence value and matching the melody to form an accompaniment.

### CROSS REFERENCE

The application claims priority from Taiwan Patent Application NO. 101133568, filed on Sep. 13, 2012, the content thereof is incorporated by reference herein.

### FIELD OF THE INVENTION

The invention relates to an accompaniment generation method, and more particularly to an automatic accompaniment generation method combining music theory and affective computing not only to generate the accompaniment that matches the melody, but also to evoke a specific emotion.

### BACKGROUND OF THE INVENTION

In general, music is an art that involves the combination of various kinds of sounds to express thoughts; it is also a carrier of thoughts. A complete piece of music includes melody and accompaniment. When the melody is played with different kinds of accompaniments, different feelings and affections, such as happiness, grieve, generosity, excitement, etc. are brought to the audience. Therefore, a deliberated and carefully planned accompaniment creates an unforgettable listening experience.

It has been found that harmony is one of the most dominant music features in musical understanding and composition. The subject of harmony involves chords, chord progressions, and the principles of connection between them. A musical chord is defined as a set of simultaneously played notes. There are several different types of chords depending on the length of interval between notes, giving each chord type a distinct sound.

The connection of different chords is generally referred to as harmonic progression. Harmonic progression is a significant emotion-evoking music feature because it contains both vertical and horizontal aspects of music information and characterizes how the chords in a chord sequence change with time. One of the evidences showing the strong relation between the harmonic progression and the perceived emotion is that similar chord sequences can be observed in songs of similar genre and emotion.

Creating proper harmonic progression to accompany a melody is crucial in music composition. Accompaniment design normally relies on a competent musician. Thayer's emotion model dimensionally defines emotion in terms of arousal (how exciting/calming) and valence (how positive/negative). With this emotion representation, it has been found that valence can be affected by chord. However, the relation between harmonic progression and valence was not fully explored. Therefore, determining the relation between harmonic progression and emotion is an important step for emotion-based accompaniment generation.

### SUMMARY OF THE INVENTION

In one aspect of the present invention, the primary objective of the present invention is to provide a method to combine music theory and affective computing to provide accompaniment compatible with music theory and expressing a specific emotion.

In order to accomplish the aforementioned objective, the method includes the steps of:
receiving a melody and a valence value;
executing an accompaniment module, wherein the accompaniment module executing step includes generating at least one harmonic progression composed of multiple chords corresponding to the valence value and matching the melody to form an accompaniment; and
outputting the accompaniment.

In one aspect of the present invention, the chords are stored in a chord database.

In still another aspect of the present invention, the accompaniment module executing step further includes the step of:
modulating an onset rate of the harmonic progression in accordance with the arousal value to generate the accompaniment.

In a preferred embodiment of the present invention, the accompaniment module executing step further includes the steps of:
modulating the harmonic progression in accordance with a selected playing mode to generate the accompaniment.

In a preferred embodiment of the present invention, the playing mode includes a block chord mode and a broken chord (arpeggio) mode.

Because an accompaniment module is included in the preferred embodiment of the present invention, the user may input a selected melody as well as a freely selected valence value to generate at least one corresponding harmonic progression in compliance with the selected arousal value and the selected playing mode to generate an accompaniment. A proper harmonic progression is one that is fully in compliance with music theory and yet evokes a specific feeling.

Through corresponding relationship between chord progression and valence value, a proper accompaniment in accordance with emotion is created.

Furthermore, the accompaniment module includes the step of modulating the onset rate of the harmonic progression in accordance with the selected arousal value to generate the accompaniment. With the modulation of the onset rate between harmonic progressions, compact, thrilled, soft, or soothing harmonic progression can be made.

As the inclusion of modulation of the playing mode of the harmonic progression, the preferred embodiment of the present invention is enriched and more flexible as the playing mode is modulated. Thus the goal in the invention is to automatically generate music accompaniment for a given melody to evoke specific emotions and help people experience the fun of music composition.

### BRIEF DESCRIPTION OF THE DRAWINGS

FIG. 1 is a flow chart explaining the execution of automatic accompaniment generation in response to valence of the present invention;

FIG. 2 is another flow chart of the preferred embodiment explaining the execution of automatic accompaniment generation in response to emotion (valence and arousal) and playing mode of the present invention;

FIG. 3 is still another flow chart of the preferred embodiment explaining the execution of automatic accompaniment generation in response to emotion (valence and arousal) and playing mode of the present invention;

FIG. 4 is a schematic view showing the valence value of the harmonic progression path of the present invention;

FIG. 5 is still another schematic view showing the graphic user interface for the preferred embodiment of the present invention;

FIG. 6a is a schematic view showing the relationship between onset rate and the arousal value under block chord playing mode; and FIG. 6b is still another schematic view showing the relationship between onset rate and the arousal value under arpeggio playing mode.

### DETAILED DESCRIPTION OF THE INVENTION

Other features and advantages of the invention will become apparent after introduction of the following detailed description of preferred embodiments with reference to the accompanying drawings.

For a given melody, one embodiment of the present invention generates emotion-based accompaniment according to the user-specified valence, arousal, and playing mode. Various accompaniments can be generated by changing arousal and valence. The valence determines how chords for each melody note are connected, and the arousal determines the onset rate.

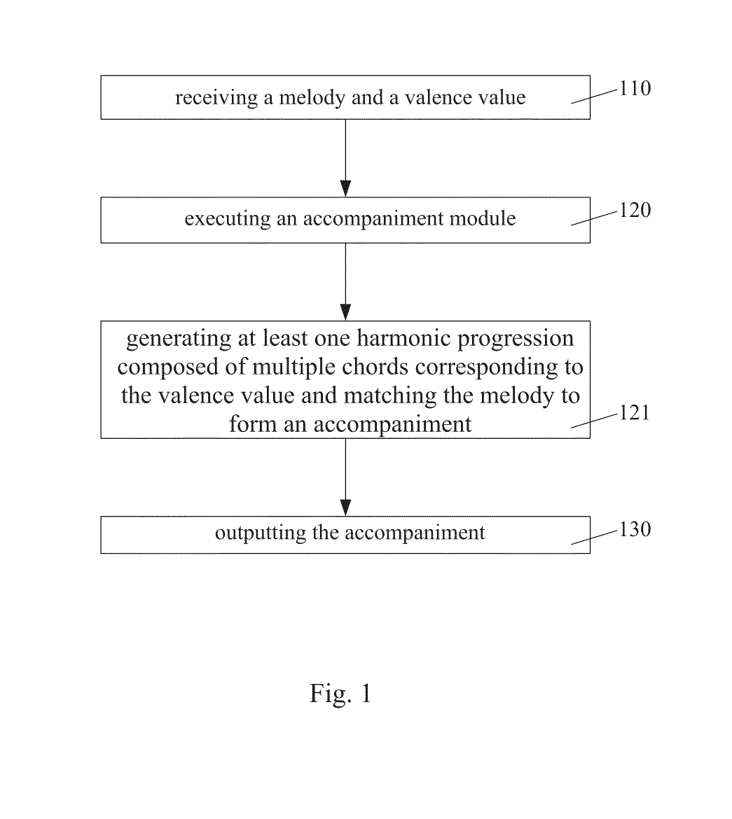

With reference to FIG. 1, a method for automatic accompaniment generation to evoke a specific emotion includes the steps of:
110: receiving a melody and a valence value;
120: executing an accompaniment module, wherein the accompaniment module execution includes the step of:
   121: generating at least one harmonic progression composed of multiple chords corresponding to the valence value and matching the melody to form an accompaniment; and
130: outputting the accompaniment.

In the melody and valence value receiving step 110, a selected melody in MIDI format is read and analyzed for its music features such as pitch, rhythm, mode, meter and tempo. These features are recorded for later process during accompaniment generation. In the step of accompaniment module executing step 120, for each note of the melody, the embodiment finds appropriate chords from the chord database to accompany it. A chord is a combination of three or more tones heard as if sounding simultaneously. In one embodiment triads (three-note chords) are saved in the chord database and used during the accompaniment composition. In the step of 121, the harmonic progression is composed of multiple chords. Each harmonic progression has its own corresponding valence value and brings a different listening affection to the listener(s). The valence value ranges from negative 10 to positive 10 and is determined by user. The higher the valence value is, the more positive the accompaniment becomes. However, the lower the valence value is, the more negative the accompaniment becomes.

In the accompaniment outputting step 130, after the accompaniment with a specific valence value is generated by the accompaniment module, the accompaniment is output to complete the automatic accompaniment method of the preferred embodiment of the present invention.

The embodiment provides a method that considers how to bring valence into effect by harmonic progression in the automatic generation of music accompaniment to fit a melody. The relation between harmonic progression and valence is determined subjectively to enhance the perceptual quality of the accompaniment.

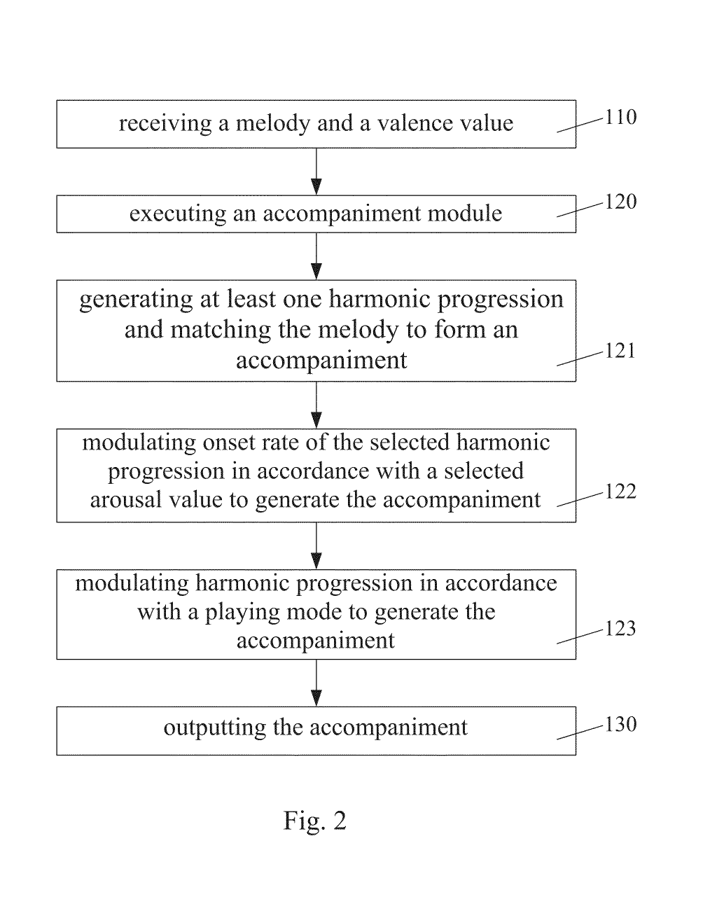

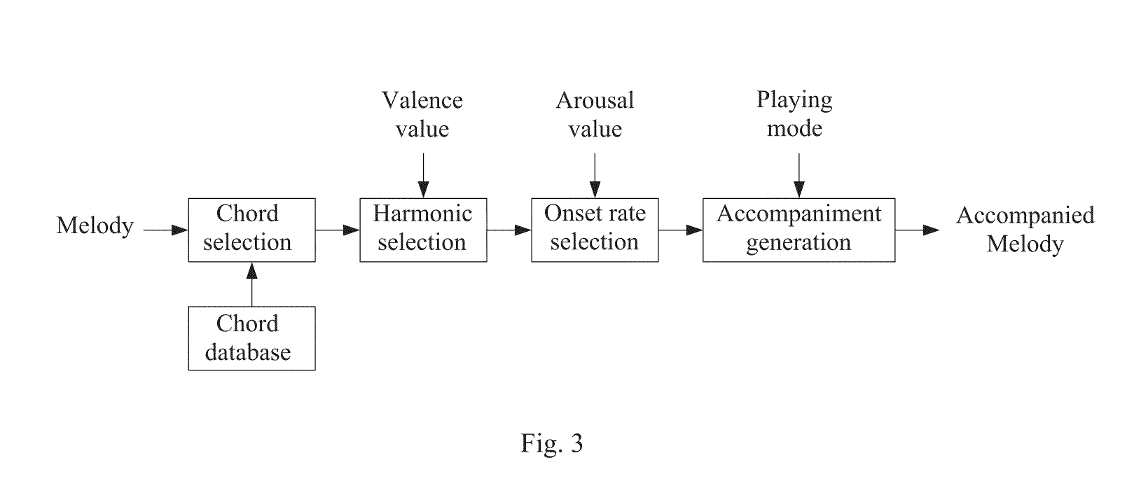

With references to FIGS. 2 and 3, in this preferred embodiment of the present invention, only the differences with the first embodiment will be described. It is noted that the method for automatic accompaniment generation to evoke specific emotion includes the steps of:
110: providing a melody and a valence value;
120: executing an accompaniment module, wherein the accompaniment module execution includes the steps of:
   121: generating at least one harmonic progression composed of multiple chords corresponding to the valence value and matching the melody;
   122: modulating onset rate of the harmonic progression in accordance with a selected arousal value;
   123: modulating the harmonic progression in accordance with a playing mode to generate a accompaniment; and
130: outputting the accompaniment.

In the harmonic progression generating step 121, at least one appropriate harmonic progression is generated in accordance with music theory and valence value.

After the harmonic progression is selected, the embodiment determines the onset rate and the mode of the accompaniment from the arousal and playing mode input and generates the accompaniment. The embodiment is capable of generating emotion-based accompaniments for melodies. Various accompaniments can be generated by changing the arousal and valence parameters.

Furthermore, the accompaniment module of the present invention has the following features.

In the chord density modulating step 122, the onset rate of the harmonic progression may be modulated in accordance with a selected arousal value. More specifically, onset rate is the number of music events in a time interval. In general, if more notes are played within a specific time period, the accompaniment is tenser and thus has higher arousal value. On the contrary, if fewer notes are played in the specific time period, the accompaniment tends to be soft and relaxing and thus has lower arousal value. Therefore, a user may program the invention in accordance with the requirements. For example, the arousal value may range from negative 10 to positive 10 (−10˜+10). The higher the value is, the more exciting the accompaniment becomes and the lower the value is, the more peaceful the accompaniment becomes. Thus, the harmonic progression has variations of tense and excitement and/or soft and relaxing.

In the harmonic progression modulating step 123, the harmonic progression may be modulated in accordance with a playing mode. In the preferred embodiment of the present invention, the playing mode includes, but not limited to, a block chord mode and a broken chord mode.

A chord is a vertical unit in essence. It consists of a group of three or more tones that function simultaneously. The simplest and most basic way to present it is a block chord, with all the tones played simultaneously at once.

Tones in a chord can also be presented one after the other since human ear and memory can group these tones into a unit. A chord presented in this way is called an arpeggio or a broken chord. The arpeggio mode helps create a smooth, sustained, flowing sound on the piano.

With reference to FIG. 2 again, in step 121, multiple harmonic progressions complying with the music theory and the selected valence value are generated for the user to choose. In the onset rate modulating step 122, onset rate of the harmonic progression is modulated according to the arousal value to allow the accompaniment to have various arousals. Step 123 modulates the playing mode. Preferably, the playing mode includes a block chord mode and a broken chord mode.

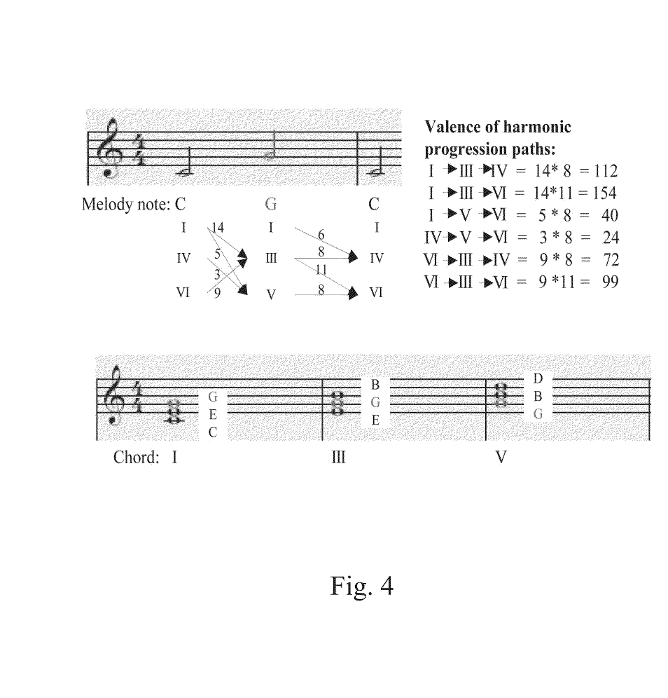

With reference to FIGS. 4, different chords are selected to accompany the three-note melody. With different connections of chords, different harmonic progressions are formed. In this embodiment, Roman numerals are used to represent the chords. Multiple valence values of harmonic progression paths are shown in the accompanying drawings, ex., I->III->IV=14*8=122. That is, the valence value of the harmonic progression path is 122, calculated by multiplying the valence value of chord pair I->III (14) and that of chord pair III->IV (8) together. The valence value of the chord pair is determined and evaluated subjectively.

The preferred embodiments of the present invention combine music theory and affective computing to automatically generate accompaniment. The affective computing is to judge the user's emotion or affection via biological information, words, tone, expressions, etc. As such, the present invention can be used to evoke a specific affection, not just to generate an accompaniment complying with the music theory.

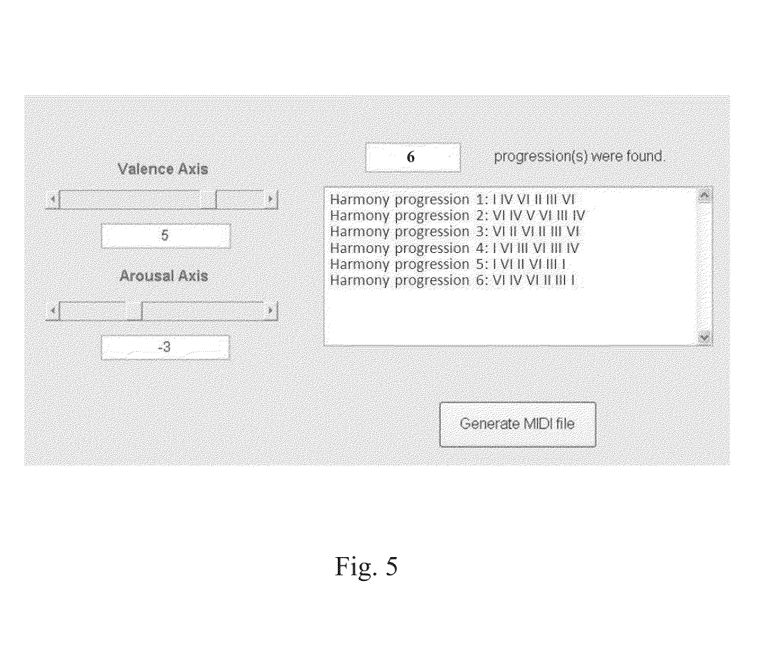

The user's graphic interface is shown in FIG. 5. It is to be noted that six harmonic progression matches are shown on the right side, which are generated in step 121. The harmonic progression is composed of chords represented by multiple Roman numerals. Left side of the drawing indicates the valence value and the arousal value. When the selection is input, the harmonic progressions matching the selected valence value and the arousal value are displayed on the right side. The user may then select one and press the “Generate MIDI file” key to output the accompaniment. In this embodiment of the present invention, the valence value is 5 and the arousal value is −3.

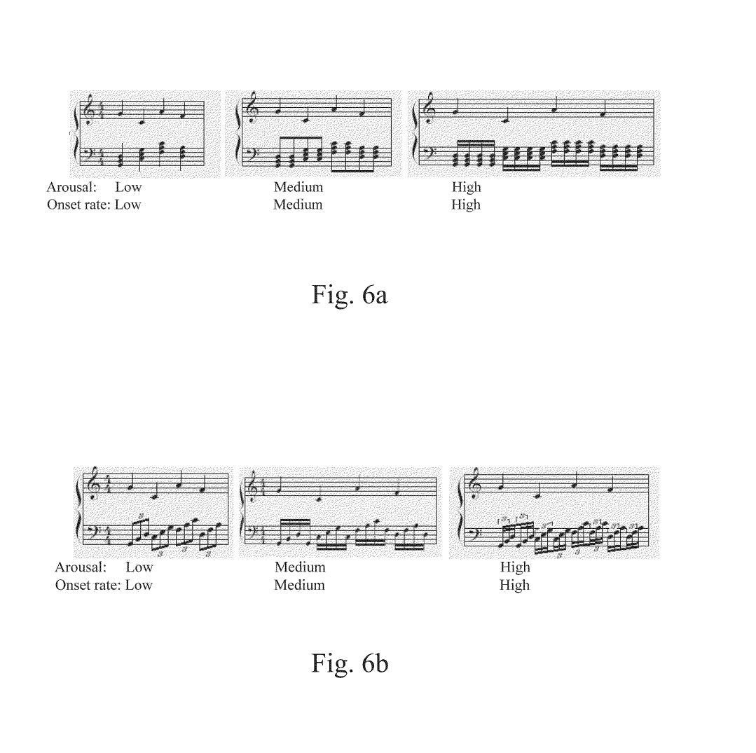

With reference to FIGS. 6a and 6b, it is noted that with different densities of the accompaniments, different arousals are evoked. If the onset rate is low, which represents fewer notes within a specific time period, the arousal value is low. Instead, if the onset rate is high, i.e. more notes within a specific time period, the arousal value is high. Different music playing modes are displayed in these two figures. Block chord mode is depicted in FIG. 6a and arpeggio mode is depicted in FIG. 6b.

FIG. 6a shows how different arousal can be evoked by changing the onset rate of block chord accompaniment. Specifically, accompaniments of denser block chords are generated as the input arousal increases. There are different ways of presenting a broken chord. The patterns of broken chords provided by the invention are shown in FIG. 6b, wherein the patterns vary with onset rates to evoke different arousal.

Accordingly, music pieces that are faster, louder, staccato, and have a higher onset rate are usually found to be more arousing, and vice versa. The onset rate, defined as the number of music events in a time interval, is one of the most effective and important features that affect arousal.

With reference to all the accompanying drawings, the embodiment of the present invention, when compared with the conventional technique, has the following advantages:

The combination of music theory and affective computing allows generation of music accompaniment that complies with music theory and evokes specific emotion from listeners. For example, an accompaniment generated with high valence value and high arousal value induces positive emotions such as joyfulness and excitement for the invention.

Accordingly, the invention of music accompaniment method can generate accompaniments according to the user-specified valence/arousal values, and a user can quest the desired accompaniment by continuously adjusting the valence/arousal values until the output of the method is satisfactory. Therefore, the invention automatically generates music accompaniment for a given melody to evoke specific emotions and help people experience the fun of music composition.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for automatic accompaniment generation to evoke specific emotion comprising the steps of:
receiving a melody and a valence value;
executing an accompaniment module, wherein the accompaniment module executing step includes generating at least one harmonic progression composed of multiple chords corresponding to the valence value and matching the melody to form an accompaniment; and
outputting the accompaniment.

2. The method as claimed in claim 1, wherein the chords are stored in a chord database.

3. The method as claimed in claim 1, wherein the accompaniment module executing step further includes the step of:
modulating an onset rate of the harmonic progression in accordance with an arousal value to generate the accompaniment.

4. The method as claimed in claim 1, wherein the accompaniment module executing step further includes the step of:
modulating the harmonic progression in accordance with a selected playing mode to generate the accompaniment.

5. The method as claimed in claim 3, wherein the accompaniment module executing step further includes the step of:
modulating the harmonic progression in accordance with a selected playing mode to generate the accompaniment.

6. The method as claimed in claim 4, wherein the playing mode includes a block chord mode and a broken chord mode.

7. The method as claimed in claim 5, wherein the playing mode includes a block chord mode and a broken chord mode.
